(19) United States
(12) Patent Application Publication
(10) Pub. No.: US 2009/0127523 A1
(43) Pub. Date: May 21, 2009

(54) LIFTING JACK

(76) Inventor: Stuart Mangham, Bedfordale (AU)

Correspondence Address: MERCHANT & GOULD PC, P.O. BOX 2903, MINNEAPOLIS, MN, 55402-0903, US

(21) Appl. No.: 11/913,012

(22) PCT Filed: Apr. 28, 2006
(86) PCT No.: PCT/AU06/00591

§ 371 Date: Jun. 19, 2008

(30) Foreign Application Priority Data
Apr. 28, 2005 (AU) 2005902125
Nov. 11, 2005 (AU) 2005906257

(51) Int. Cl. B66F 5/04

(52) U.S. Cl. 254/2 B; 254/93 H

(57) ABSTRACT

A lifting jack (10) includes a jacking portion (11) carried on a mobile frame (13). The jacking portion (11) includes a jacking ram (15) and has a jacking axis (61) corresponding to the direction along which the jacking ram (15) can extend. The jacking portion (11) also has a base (19) adapted for engagement with the ground (23) with the jacking axis (61) extending substantially vertically. The mobile frame (13) supports the jacking portion (11) for movement across the ground (23) and includes two ground wheels (33) rotatable about a substantially horizontal axis The jacking portion (11) has a first mode of operation in which the base (19) is in engagement with the ground (23) and the jacking axis (61) extends substantially vertically. The jacking portion (11) also has a second mode of operation in which the base (19) is elevated above the ground (23) and the jacking axis (61) extends substantially vertically. The jacking portion (11) also has a third mode of operation in which the jacking portion (11) has been rotated upwardly about the horizontal axis into a tilted condition facilitating wheeling movement of the lifting jack over the ground.

### FIELD OF THE INVENTION

This invention relates to a lifting jack.

The invention has been devised particularly, although not necessarily solely, as a lifting jack for lifting heavy loads such as heavy construction machinery, rail cars and ore trucks.

### BACKGROUND ART

It is known to utilise lifting jacks for lifting heavy loads, such as loads of the type referred to above.

Typically, such a lifting jack comprises wheels for moving the lifting jack across the ground and a base adapted to rest on the ground during the lifting operation. The wheels are clear of the ground when the base is reflecting on the ground. In order to utilise the wheels for moving the jack, it is necessary to rock the jack about the base so as to bring the wheels into contact with the ground. Typically, the base is configured to facilitate the rocking action. Once the wheels are in contact with the ground, the base can be rotated about the axis of rotation of the wheels so as to move clear of the ground and thereby allow movement of the lifting jack by rolling of the wheels across the ground.

While such an arrangement does permit the lifting jack to be moved relatively conveniently from one location to another, it is not particularly convenient for making small adjustments to the position of the lifting jack once located under a load to be lifted. It is often the case that there is insufficient clearance below the load for the jack to be rocked about the base into a position in which the wheels can engage the ground. Because of the limited clearance available, it may also be necessary to adjust the position of the jack by sliding the base over the ground. This can be a difficult and strenuous task, particularly as some lifting jacks can weigh in the order of 300 kilograms. Because of the need to manoeuvre the jack in position by sliding the base across the ground, it can also be difficult to locate the jack at the desired lifting position under the load. Further, if the base is configured to facilitate the rocking action then it may not necessarily be of an optimum configuration for supporting the load.

It is against this background and the problems and difficulties associated therewith that the present invention has been developed.

### DISCLOSURE OF THE INVENTION

According to a first aspect of the invention there is provided a lifting jack comprising a jacking portion defining a jacking axis, the jacking portion having a base adapted for engagement with the ground with the jacking axis extending substantially vertically, a mobile frame supporting the jacking portion for movement across the ground, the jacking portion having a first mode of operation in which the base is in engagement with the ground and the jacking axis extending substantially vertically, and a second mode of operation in which the base is elevated above the ground and the jacking axis extending substantially vertically.

The term “ground” as used herein includes any underlying surface or structure on which the lifting jack is supported, including a road, a paved area, a floor or a platform.

Preferably, the location of the jacking axis when the jacking portion is in the second mode of operation is substantially coincident with, or at least in close proximity to, the location of the jacking axis when the jacking portion is in the first mode of operation. This is particularly advantageous as it allows the jacking portion to be positioned in alignment with the load to be lifted while in the second mode and to then assume the first mode to perform the actual lifting operation. In this way, positioning of the lifting jack with respect to the load to be lifted is relatively easy.

Preferably, the jacking portion has a third mode of operation in which the jacking portion has been rotated upwardly into a tilted condition to facilitate movement of the lifting jack over the ground.

Preferably, the mobile frame comprises at least one, and more preferably two, ground-engaging means (such as wheels or rollers) rotatable about a substantially horizontal axis for movement across the ground.

Preferably, the jacking portion is located above the horizontal axis when in the third mode of operation.

The mobile frame may further comprise a handle means for effecting movement of the mobile frame.

Preferably, the mobile frame is selectively rotatable about the horizontal axis for moving the jacking portion between the three modes of operation.

The jacking portion may be connected to the mobile frame for pivotal movement about an axis substantially parallel to the horizontal axis. In this way, the jacking axis can remain substantially vertical when the jacking portion is in the first and second modes and also while moving between those modes.

The jacking portion may be so connected to the mobile frame by being pivotally suspended therefrom for limited pivotal movement with respect to the mobile frame. Because there is only limited pivotal movement of the jacking portion relative to the mobile frame, tilting of the jacking portion is accomplished upon movement to an extent outside the range of the limited pivotal movement.

Preferably, the lifting jack incorporates a handle mechanism comprising a shaft portion pivotally moveable into and out of a locking position and a lock for releasably locking the shaft portion in the locking position, the lock comprising a locking pin moveable between engaging and release conditions and an actuator operably connected to the locking pin whereby the locking pin is moveable from the engaging conditions into the release conditions upon operating of the actuator, the shaft portion comprising a tubular shaft and the actuator comprising an elongate element accommodated within the tubular shaft, one end of the elongate element being operably connected to the locking pin and the other end of the elongate element being connected to an actuating device.

Preferably, the elongate element comprises a rigid shaft.

Preferably, the locking pin is moveable axially along a first axis between the engaging and release conditions.

Preferably, the lock further comprises a slider adapted to undergo reciprocatory movement along a second axis substantially normal to the first axis, the slider being operably connected to the locking pin whereby movement of the slider along the second axis causes movement of the locking pin along the first axis.

Preferably, the slider presents a pair of opposed faces disposed angularly with respect to the second axis, the opposed faces being adapted for sliding engagement with abutment faces on the locking pin.

Preferably, the locking pin incorporates a slot in which the slider is received, the opposed faces of the slot defining the abutment faces.

Preferably, guide means are provided for guiding the slider during reciprocatory movement thereof.

According to a second aspect of the invention there is provided a lifting jack comprising a jacking portion defining a jacking axis, the jacking portion having a base adapted for engagement with the ground with the jacking axis extending substantially vertically, a mobile frame supporting the jacking portion for movement across the ground, the mobile frame comprising at least one ground-engaging means rotatable about a substantially horizontal axis for movement across the ground, the jacking portion having a first mode of operation in which the base is in engagement with the ground and the jacking axis extends substantially vertically, a second mode of operation in which the base is elevated above the ground and the jacking axis extends substantially vertically, and a third mode of operation in which the jacking portion has been rotated upwardly about the horizontal axis

Preferably, the jacking portion is located above the horizontal axis when in the third mode of operation.

### BRIEF DESCRIPTION OF THE DRAWINGS

The invention will be better understood by reference to the following description of several specific embodiments thereof as shown in the accompanying drawings in which:

FIG. 1 is a schematic side elevational view of a lifting jack according to the embodiment, the lifting jack being shown in a first mode of operation;

FIG. 2 is a schematic front elevational view of FIG. 1;

FIG. 3 is a view similar to FIG. 1 with the exception that the lifting jack is shown in a second mode of operation;

FIG. 4 is also a view similar to FIG. 1 with the exception that the lifting jack is shown in a third mode of operation;

FIG. 5 is an elevational view of a lifting jack according to a second embodiment;

FIG. 6 is a perspective depiction of a part of a handle mechanism for the lifting jack according to a second embodiment, illustrating in particular a lock for releasably locking the handle mechanism in a selectedlocking position, with a locking pin forming part of the lock being shown in a released condition;

FIG. 7 is also a perspective depiction of part of the handle mechanism illustrating in particular the lock, with the locking pin being shown in an engaging condition;

FIG. 8 is a view similar to FIG. 7 with the exception that the locking pin is shown in the release condition; and

FIG. 9 is a schematic sectional view of the lock.

### BEST MODE(S) FOR CARRYING OUT THE INVENTION

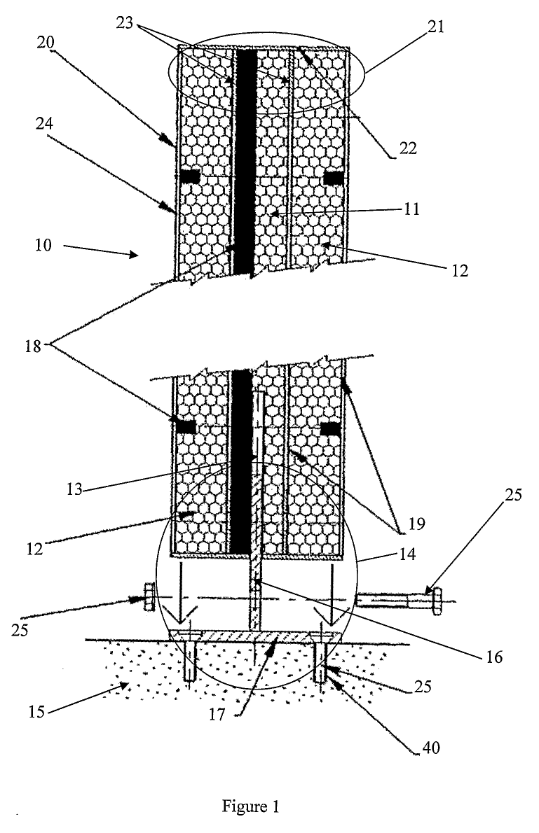

Referring to FIGS. 1 to 4 of the drawings. the first embodiment is directed to a lifting jack 10 comprising a jacking portion 11 carried on a mobile frame 13.

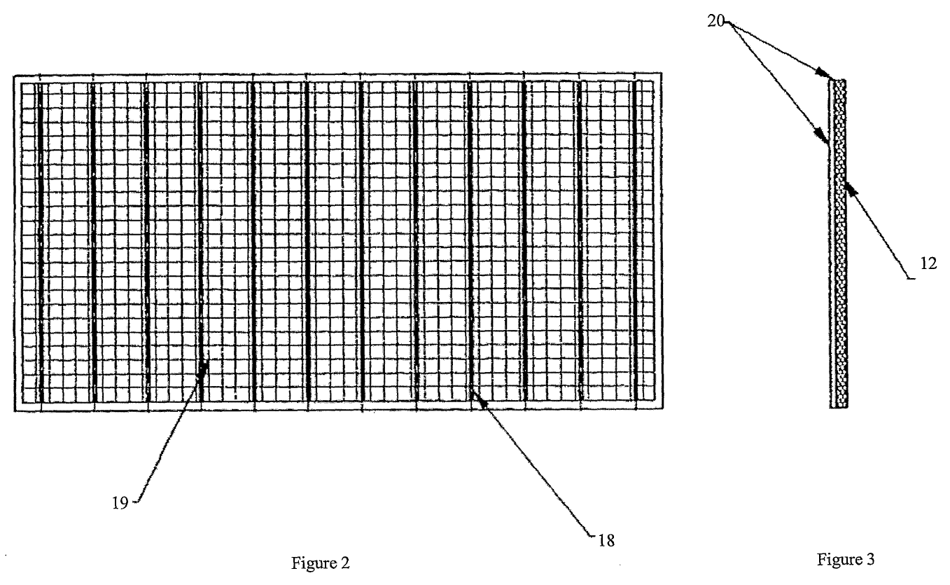

The jacking portion 10 comprises a hydraulic jacking ram 15, the upper end of which is fitted with a lifting saddle 17 and the lower end of which is fitted to a base 19. The base 19 comprises a base plate 21 adapted for engagement with the ground (which is identified by reference numeral 23 and which comprises a floor surface in this instance), an intermediate plate 25, and a spacer portion 27 carried on the intermediate plate 25. The upper end of the spacer portion 27 incorporates a recess (not shown) into which the lower end of the jacking ram 15 is received. The intermediate plate 25 supports two side arms 29 disposed on opposed sides of the spacer portion 27, as best seen in FIG. 2.

The mobile frame 23 comprises a housing 31 which has two opposed sides 32 and which is supported on ground wheels 33. The ground wheels 33 are mounted for rotation about a substantially horizontal axis 35 on stub axles 36 carried on the housing 31. In this embodiment, the wheels 33 have solid rubber tyres to limit the extent of deflection under load.

The mobile frame 13 incorporates a handle 37 for effecting movement of the mobile frame. The handle 37 comprises two side portions 38 and an upper portion 39 extending between the side portions to provide a hand grip. Each side portion 38 is connected at its lower end to the wheel stub axle 36 and is rotatable about the axle for angular movement with respect to the housing 31. A locking means 41 is provided for selectively locking the handle 37 in one of a number available positions with respect to the housing 31. The locking means 41 comprises a locking pin 43 provided on each handle side portion 38 and a plurality of locking holes 45 provided on the respective side 32 of the housing 31, the locking pin 43 being adapted to locate in a selected one of the locking holes 45 thereby to lock the handle 37 against angular movement with respect to the housing 31. In this way, the handle 37 can be set to an angular position relative to the housing 31 convenient to a user.

The housing 31 has an interior space (not shown) for accommodating various components of the lifting jack, including a hydraulic reservoir for fluid used to operate the hydraulic ram 15, a hydraulic pump and associated motor, and related componentary such as a filtration system.

The sides 32 of the housing 31 each incorporate an upper mounting flange 47 and a lower mounting flange 49.

The jacking portion 11 is connected to the mobile frame 13 for pivotal movement about a substantially horizontal axis 51. Specifically, the jacking portion 11 is pivotally suspended between the two upper mounting flanges 47 on the housing 31. This is achieved by way of two pivot pins 53, each extending between one of the upper mounting flanges 47 and the upper end of the respective side arm 29 of the jacking portion 11. Thus, the pivot pins 53 cooperate to define the horizontal axis 51 about which the jacking portion 11 can swing.

The extent to which the jacking portion 11 can swing about the horizontal axis 51 is limited by a further connection 55 between the jacking portion 11 and the mobile frame 13. The further connection 55 comprises a limit pin 57 provided on each side arm 29 adjacent the lower end thereof, and an arcuate slot 59 in the adjacent lower mounting flange 49 in which the limit pin 57 is received. The arcuate length of the slot 59 defines the extent of swinging movement for the jacking portion 11 as limited by interaction between the slot 59 and the limit pin 57 received therein.

The jacking portion 11 defines a jacking axis 61 corresponding to the direction along which the jacking ram 15 can extend and contract.

The jacking portion 11 has a first mode of operation in which the base 19 is in engagement with the ground 23 and the jacking axis 61 extends substantially vertically, as shown in FIG. 1. While in this first mode the wheels 33 are also in contact with the ground, the load lifted during operation of the lifting jack 10 is taken entirely by the jacking portion 11 and transmitted to the ground 23 through the base 19.

The jacking portion 11 also has a second mode of operation in which the base 19 is elevated above the ground 23 and the jacking axis 61 extends substantially vertically, as shown in FIG. 3. The location of the jacking axis 61 when the jacking portion 11 is in the second mode of operation is substantially coincident with, or at least in close proximity to, the location of the jacking axis 61 when the jacking portion 11 is in the first mode of operation. This allows the jacking portion 11 to be positioned in alignment with the load to be lifted while in the second mode and to then be transferred into the first mode to perform the actual lifting operation. This assists positioning of the lifting jack with respect to the load to be lifted.

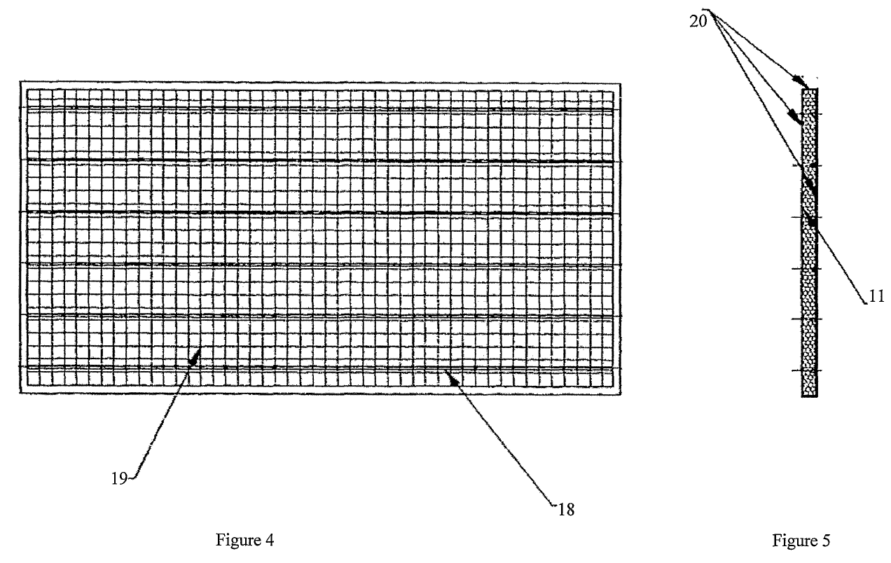

The jacking portion 11 also has a third mode of operation in which it has been rotated upwardly into a tilted condition which facilitates movement of the lifting jack over the ground, as shown in FIG. 4. The jacking portion 11 is moved into the tilted condition upon movement of the mobile frame 13 relative to the jacking position 11 by an amount beyond that accommodated by the connection 55.

The mobile frame 13 is selectively rotatable about the horizontal axis 35 (by appropriate operation of the handle 37) for moving the jacking portion 11 between the three modes of operation.

The lifting jack 10 is stored in a condition corresponding to the first mode of operation, with the base 19 in engagement with the ground 23 and the jacking axis 61 extending substantially vertically, as shown in FIG. 1. The wheels 33 are also in contact with the ground 23.

When a lifting operation is required to be performed, the lifting jack 10 is moved into the third mode of operation so that it can be wheeled over the ground 23 to the load lifting site. The lifting jack 10 is moved from the first mode to the third mode by rotating the handle 37 downwardly, causing the mobile frame 13 to pivot about horizontal axis 35 and thereby tilt the jacking portion 11 upwardly about the axis 35 into a position in which the jacking portion is disposed above that axis, as shown in FIG. 4. This is a condition in which it is convenient to wheel the lifting jack 10, as its weight is predominately above the wheel axis 35. In moving from the first mode to the third mode, the lifting jack 10 of course passes through the second mode, although that is of no consequence to the lifting operation at this stage.

Once at the load lifting site, the lifting jack 10 is required to be positioned at the desired lifting point below the load. This can be done by raising the handle 37 so that the mobile frame 13 can move into a position in which the jacking portion 11 is supported in the second mode of operation, with the base 19 is elevated above the ground 23 and the jacking axis 61 extending substantially vertically, as shown in FIG. 3. Because the base 19 is clear of the ground, the lifting jack 10 is still supported entirely on the wheels 33 and so it can be moved relatively easily by a wheeling action. Furthermore, because the jacking axis 61 extends substantially vertically, it is relatively easy to position the lifting saddle 17 directly below the desired load lifting point.

Once the lifting saddle 17 has been positioned with respect to the load lifting point, the handle 37 can be rotated to bring the jacking portion 11 into the first mode of operation in which the base 19 is in engagement with the ground 23 and the jacking axis 61 is substantially vertical, as shown in FIG. 1. This is the mode in which the jacking operation is performed. Even though the wheels 33 are also in contact with the ground 23, the load lifted during operation of the lifting jack 10 is taken entirely by the jacking portion 11 and is transmitted to the ground 23 through the base 19. In the movement from the second mode to the first mode, the jacking axis 61 remains aligned vertically with the load lifting point. This is because the location of the jacking axis 61 when the jacking portion 11 is in the first mode of operation is substantially coincident with, or at least in close proximity to, the location of the jacking axis 61 when the jacking portion 11 was in the second mode of operation and aligned with the intended load lifting point.

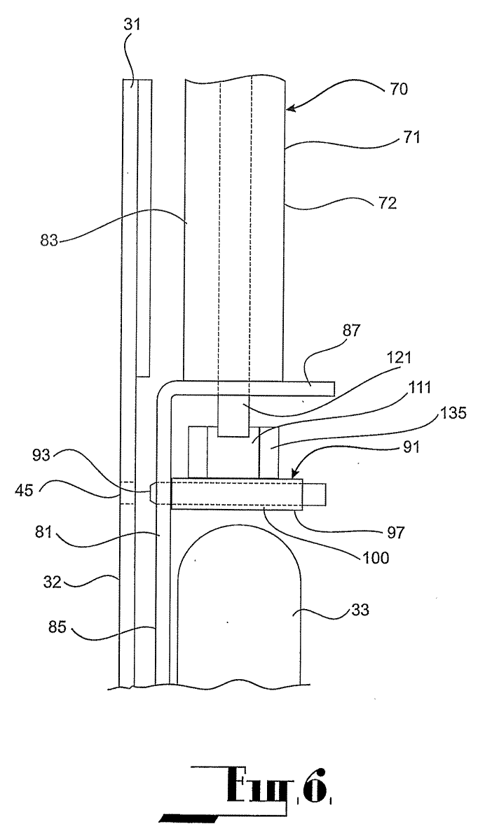

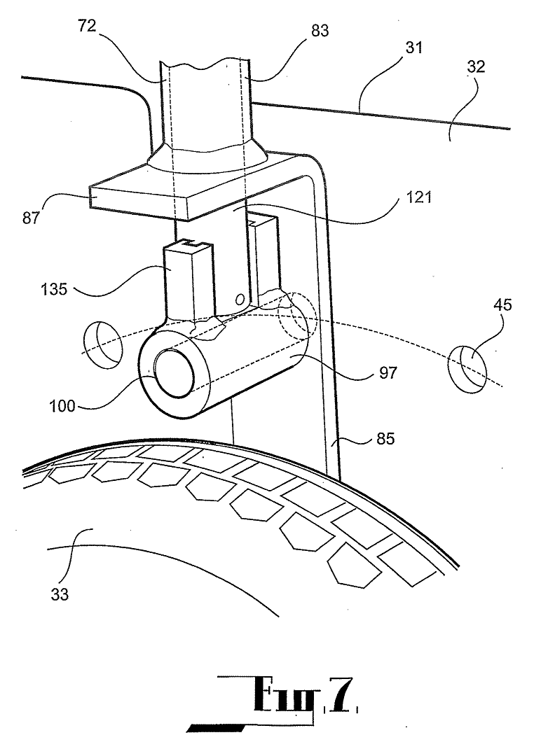

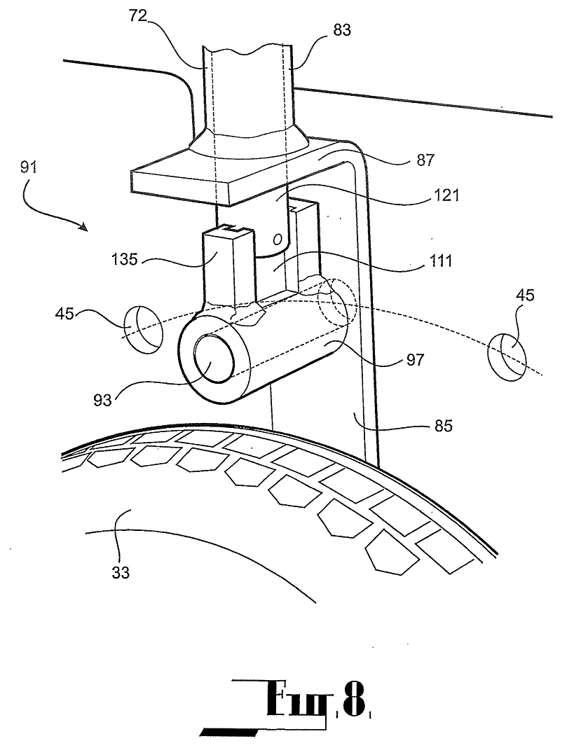

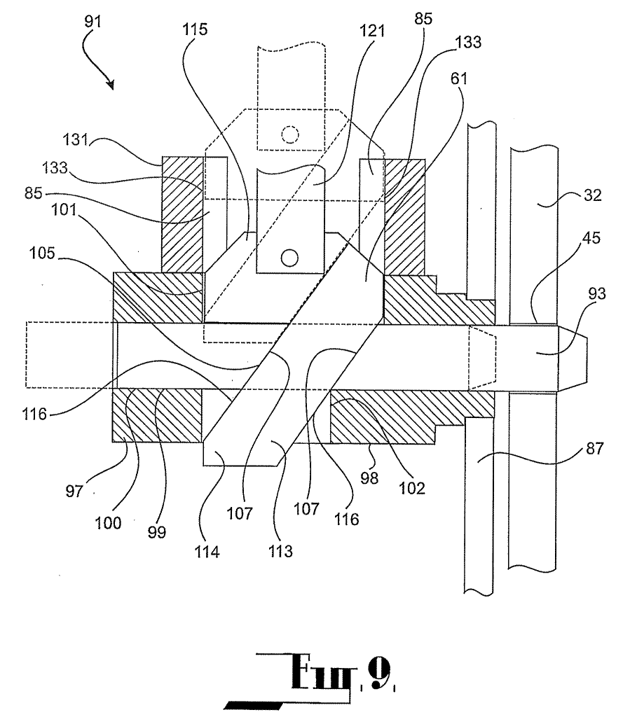

Referring now to FIGS. 5 to 9, there is shown a lifting jack according to a second embodiment. The lifting jack according to the second embodiment is similar in many respects to the lifting jack according to the first embodiment and so corresponding reference numerals are used to identify corresponding parts, where appropriate.

The lifting jack according to the second embodiment has a handle mechanism 70 which is different from the handle 37 to which it corresponds in the first embodiment.

The handle mechanism 70 comprises a handle 71 having two sides 72 each configured as a shaft portion, and an upper cross-member 73 extending between the sides 72 to provide a handgrip 74. The handle 71 also incorporates a lever bar 75 extending between the side 72 and supported for limited lateral movement, thereby functioning as a pull handle (the purpose of which will be explained later).

Each side 72 of the handle 71 comprises a lower portion 81 and an upper portion 83. The lower portion 81 comprises a bar 85 pivotally mounted at its lower end onto the axle 36. The bar 85 extends upwardly from the axle 36 closely adjacent the side 32 of the housing 31 and is turned outwardly at its upper end to provide a bracket 87. The upper portion 83 of the side 72 of the handle 71 is secured to the bracket 87 and is of tubular construction.

Because the bars 85 are pivotally mounted on the axles 36, the handle 71 can pivot about the axles 36. Locks 91 are provided on the two sides 72 of the handle mechanism 70 for releasably locking the handle 71 in a selected one of a plurality of available angular locking positions. The particular angular locking position selected is dependant upon the needs of the user and the particular function that the jack is to perform.

Each lock 91 comprises a locking pin 93 supported for axial movement (along a first axis) between engaging and release conditions with respect to a plurality of locking holes 45 provided in the adjacent side 32 of the housing 31. With this arrangement, the locking pin 93 can be moved into registration with any one of the locking holes 95 and moved from the release position into the engaging position to be received in a selected one of the holes, thereby locking the handle 71 with respect to the mobile frame 13 at the corresponding handle position.

The locking pin 93 is supported for axial sliding movement in a support barrel 97 mounted at one end on the outer side of the bar 85. The bar 85 of course has a hole matching the bore 100 of the barrel 97 to permit sliding movement of the locking pin 93 along the barrel and through the hole for entry into the selected locking hole 45 in the mobile frame 13.

The barrel 97 has an outer wall 98, and an inner wall 99 defining the bore 100 in which the locking pin 93 is slidably accommodated. A first slot 101 extends between the inner and outer walls 99, 98 of the barrel. A second slot 102, which is in opposed relation to the first slot 101, also extends between the inner and outer walls 99, 98 of the barrel 97.

The locking pin 93 has a transverse slot 105, the ends of which define abutment faces 107. The abutment faces 107 are inclined to the longitudinal axis of the pin, as shown in FIG. 9.

The lock 91 further comprises a slider 111 supported for reciprocatory movement along second axis transverse to the longitudinal axis of the locking pin (i.e. the first axis). The slider 111 comprises an operating portion 113 configured as a finger 114 and a carriage portion 115 from which the finger 114 projects. The finger 114 is configured and dimensioned to be received within the slot 115 in the locking pin 93. The finger 114 presents two opposed faces 115 disposed angularly with respect to the direction of reciprocatory movement of the slider 111 (i.e. the second axis), the opposed faces being adapted for sliding engagement with the abutment faces 107 at the ends of the slot 105 in the locking pin 93 within which the finger 114 is received.

The finger 114 is accommodated in the second slot 102 when the slider 111 is in its lowermost position (as shown in FIG. 9).

The slider 111 is connected to the lower end of an actuating rod 121, the upper end of which is connected to the lever bar 75. The actuating rod 121 extends between the slider 111 and the lever bar 75 through the interior of the tubular upper portion 83 of the handle 71. With this arrangement, actuation of the lever bar 75 causes reciprocatory movement of the slider 111.

The slider 111 is guided for each reciprocatory movement by way of guide means 131. The guide means 131 comprises guide surfaces 133 defined by the ends of the first slot 101 in the barrel 97 and guide tracks 135 mounted on the barrel 97 to captively guide the carriage portion 115 of the slider 111 through its reciprocatory motion.

Because of the angular relationship between the finger 114 of the slider 111 and the direction of travel of the slider, reciprocatory motion of the slider along the second axis causes the locking pin 93 to undergo reciprocatory motion in its axial direction along the first axis between the release and engaging conditions. Specifically, upward movement of the slider 111 causes the locking pin 93 to move from the engaging condition to the release condition, and downward movement of the slider 111 causes the locking pin 93 to move from the release condition to the engaging condition.

As mentioned above, movement of the slider 111 is controlled by operation of the lever bar 75. The lever bar 75 is biased in any appropriate way (such as by way of a spring) into a position which disposes the slider 111 in its lowermost position corresponding to the locking condition of the locking pin 93 (as shown in full lines in FIG. 9). Pulling the lever bar 75 towards the handgrip 74 of the handle 71 lifts the actuating rod 121 to cause the slider 111 to move upwardly into its uppermost position corresponding to the release condition of the locking pin 93 (as shown in dotted outline in FIG. 9).

From the foregoing, it is evident that the present embodiments each provide a simple yet highly effective lifting jack that can be wheeled conveniently over the ground and which can be positioned relatively easily below a load which is required to be lifted.

It should be appreciated that the scope of the invention is not limited to the scope of the embodiment described.

Modifications and improvements may be made with departing from the scope of the invention.

Throughout the specification, unless the context requires otherwise, the word “comprise” or variations such as “comprises” or “comprising”, will be understood to imply the inclusion of a stated integer or group of integers but not the exclusion of any other integer or group of integers.

1. A lifting jack comprising a jacking portion defining a jacking axis, the jacking portion having a base adapted for engagement with the ground with the jacking axis extending substantially vertically, a mobile frame supporting the jacking portion for movement across the ground, the jacking portion having a first mode of operation in which the base is in engagement with the ground and the jacking axis extending substantially vertically, and a second mode of operation in which the base is elevated above the ground and the jacking axis extending substantially vertically.

2. A lifting jack according to claim 1 wherein the location of the jacking axis when the jacking portion is in the second mode of operation is substantially coincident with, or at least in close proximity to, the location of the jacking axis when the jacking portion is in the first mode of operation.

3. A lifting jack according to claim 1 wherein the jacking portion has a third mode of operation in which the jacking portion has been rotated upwardly into a tilted condition to facilitate movement of the lifting jack over the ground.

4. A lifting jack according to claim 3 wherein the jacking portion is located above the horizontal axis when in the third mode of operation.

5. A lifting jack according to claim 1 wherein the mobile frame comprises at least one ground-engaging means rotatable about a substantially horizontal axis for movement across the ground.

6. A lifting jack according to claim 5 wherein there are two ground-engaging means disposed one to each side of the jacking portion.

7. A lifting jack according to claim 1 wherein the mobile frame is selectively rotatable about the horizontal axis for moving the jacking portion between the three modes of operation.

8. A lifting jack according to claim 7 wherein the mobile frame further comprises a handle means operable for effecting movement of the mobile frame.

9. A lifting jack according to claim 8 wherein the handle means is operable to effect movement of the mobile frame across the ground and also rotatable movement of the mobile frame about the horizontal axis.

10. A lifting jack according to claim 1 wherein the jacking portion is connected to the mobile frame for pivotal movement about an axis substantially parallel to the horizontal axis.

11. A lifting jack according to claim 10 wherein the jacking portion is connected to the mobile frame by being pivotally suspended therefrom for limited pivotal movement with respect to the mobile frame.

12. A lifting jack according to claim 11 wherein the mobile frame comprises two mounting flanges and wherein the jacking portion is pivotally suspended between the two mounting flanges by way of two pivot pins each extending between one of the mounting flanges and an upper end portion of the jacking portion, the pivot pins cooperating to define the axis about which the jacking portion can pivot.

13. A lifting jack according to claim 12 further comprising a connection between the jacking portion and the mobile frame to provide for said limited pivotal movement of the jacking portion with respect to the mobile frame, the connection comprising a limit pin provided on each side of the jacking portion adjacent a lower end thereof and a corresponding arcuate slot in the adjacent mounting flange in which the limit pin is received, the arcuate length of the slot defining the extent of pivotal movement for the jacking portion as limited by interaction between the slot and the limit pin received therein

14. A lifting jack according to claim 1 wherein the jacking portion comprises a hydraulic jacking ram the upper end of which is fitted with a lifting saddle and the lower end of which is fitted to the base.

15. A lifting jack according to claim 14 wherein the jacking portion further comprises two side arms mounted on the base and disposed on opposed sides of the jacking axis, each side arm supporting one of the pivot pins adjacent the upper end thereof and also supporting one of the limit pins adjacent the lower end thereof.

16. A lifting jack comprising a jacking portion defining a jacking axis, the jacking portion having a base adapted for engagement with the ground with the jacking axis extending substantially vertically, a mobile frame supporting the jacking portion for movement across the ground, the mobile frame comprising at least one ground-engaging means rotatable about a substantially horizontal axis for movement across the ground, the jacking portion having a first mode of operation in which the base is in engagement with the ground and the jacking axis extends substantially vertically, a second mode of operation in which the base is elevated above the ground and the jacking axis extends substantially vertically, and a third mode of operation in which the jacking portion has been rotated upwardly about the horizontal axis.

17. A lifting jack according to claim 9 wherein the handle means comprises a handle mechanism comprising a lever pivotally moveable into and out of a first position and a lock for releasably locking the lever in the first position, the lock comprising a locking pin moveable between engaging and release conditions and an actuator operably connected to the locking pin wherein the locking pin is moveable from the engaging conditions into the release conditions upon operating of the actuator, the lever comprising a tubular shaft and the actuator comprising an elongate element being operably connected to the locking pin and the other end of the elongate element being connected to an actuating device.

18. A lifting jack according to claim 1 further comprising a handle mechanism comprising a lever pivotally moveble into and out of a position and a lock for releasably locking the lever in the position, the lock comprising a locking pin moveable between engaging and release conditions and an actuator operably connected to the locking pin whereby the locking pin is movable from the engaging conditions into the release conditions upon operating of the actuator, the lever comprising a tubular shaft and the actuator comprising an elongate element accommodated within the tubular shaft, one end of the elongate element being operably connected to the locking pin and the other end of the elongate element being connected to an actuating device.

19. A lifting jack comprising a jacking portion defining a jacking axis, the jacking portion having a base adapted for engagement with the ground with the jacking axis extending substantially vertically, a mobile frame supporting the jacking portion for movement across the ground, the frame comprising at least one ground engaging means rotatable about a substantially horizontal axis for movement across the ground, the jacking portion having a first mode or operation in which the base is in engagement with the ground and the jacking axis extends substantially vertically, a second mode of operation in which the base is elevated above the ground and the jacking axis extends substantially vertically, and a third mode of operation in which the jacking portion has been rotated upwardly about the horizontal axis.

20-21. (canceled)
